(19) United States
(12) Patent Application Publication
(10) Pub. No.: US 2007/0129049 A1
(43) Pub. Date: Jun. 7, 2007

(54) System and gateway system for managing phone numbers and user IDs

(75) Inventors: Satoshi Endo, Tokyo (JP); Yasuhiro Oishi, Tokyo (JP); Takashi Ito, Saitama-shi (JP); Daisuke Kikuchi, Yokohama-shi (JP); Jun Hirai, Yokohama-shi (JP)

Correspondence Address: MICHAUD-DUFFY GROUP LLP, 306 INDUSTRIAL PARK ROAD, SUITE 206, MIDDLETOWN, CT, 06457, US

(73) Assignee: NTT DoCoMo, Inc., Tokyo (JP)

(21) Appl. No.: 11/602,752

(22) Filed: Nov. 20, 2006

(30) Foreign Application Priority Data
Nov. 24, 2005 (JP) 2005-339107

(51) Int. Cl. H04Q 7/20; H04M 11/00

(52) U.S. Cl. 455/403

(57) ABSTRACT

In a service providing server, a transfer/re-assignment detection section detects that a transfer or re-assignment has occurred from information notified from a customer information management apparatus, and in response to this, a user ID creation section creates a user ID to identify a new user. A contract information management section stores the user information containing the user ID in correspondence with the phone number and a service component acquires the user ID corresponding to the phone number of the mobile phone with reference to the user information.

The present disclosure relates to subject matters contained in Japanese Patent Application No. 2005-339107 filed on Nov. 24, 2005, which are expressly incorporated herein by reference in its entireties.

### BACKGROUND OF THE INVENTION

1. Field of the Invention

The present invention relates to a system and a gateway system for managing user IDs used by an information(contents and/or service) provider to identify users who access through cellular phone terminals.

2. Description of the Prior Art

A service providing server for Internet connections (gateway system) is provided for interconnecting a cellular phone network and the Internet to support access to a content provider from cellular phone terminals. Such a service providing server converts the phone number of a cellular phone terminal to user identification information (hereinafter, referred to as “user ID”) other than the phone number using conversion logic, adds the user ID to a request from the cellular phone terminal and sends it out to the Internet. The service providing server creates and manages user information which stores phone numbers in correspondence with user IDs. Since the service providing server stores user information containing phone numbers in correspondence with user IDs, it is not necessary to refer to a database of a customer information management apparatus in which detailed information on contractors is registered every time, and it is possible to execute processing without referencing the database and thereby reduce the load.

However, there is a possibility that the ownership of a cellular phone terminal may be transferred to another person from the current contractor (change of name). Furthermore, a phone number which is assigned to a new contractor may be a phone number which was used by a different person in the past (not used at present), that is called re-assignment or re-assigned.

When a contractor is changed due to a transfer or re-assignment, the phone number does not change, and therefore the service providing server transmits the same user ID to the content provider, producing the following inconvenience. That is, if the user ID registered in the content provider is not deleted at the time of a transfer or cancellation, the personal information of the user who transferred the ownership and personal information of the previous user before a re-assignment can be referenced.

Therefore, when a transfer or cancellation or the like takes place, the content provider is informed of such contract change information (cancellation, change in the model grade and so on) so as to update the database of the content provider. More specifically, erasure requesting mail which puts together contract change information corresponding to one day is transmitted to the content provider in the night time.

Furthermore, taking into consideration a time required after sending the erasure requesting mail until the database of the content provider is updated, the service providing server places restrictions on the usage of a service in response to access from the cellular phone terminal of the contractor for a predetermined period of time (e.g., one day) after the transfer or the re-assignment.

However, when the service providing server places the above described restrictions on the usage of a service, there is a problem that even after the contract is completed there exists a period during which the service is not available. Furthermore, unless the content provider updates the database according to the erasure requesting mail, there is a possibility that the personal information of the user who transferred the ownership or the previous user before a re-assigned may be mistakenly displayed even after a lapse of predetermined period of time.

### SUMMARY OF THE INVENTION

It is an object of the present invention to provide a gateway system which makes various services according to contract contents available immediately after a contract is completed and prevents personal information of a previous user from being mistakenly displayed even when accessed before the content provider updates a database thereof.

An aspect of the present invention is a system which manages phone numbers uniquely assigned to individual mobile phones for communication on a cellular phone network in correspondence with user IDs uniquely assigned to the respective users of the mobile phones to identify the users by a server on a network other than the above described cellular phone network, including a detection section that detects the occurrence of a transfer of a mobile phone whose user information including a phone number and user ID is managed in the above described system or a re-assignment of a phone number identical to a phone number of a mobile phone whose user information was managed in the past in the above described system, creation section that creates a new user ID for a new user to whom said mobile phone has been transferred or the same phone number has been re-assigned when the above described detection section detects the above described transfer or re-assignment and a management section that associates the new user ID for the above described new user created by the above described user ID creation section with the phone number of the mobile phone transferred to the new user or the above described reassigned phone number and manages the phone number and new user ID as user information of the new user.

Here, when a transfer of the mobile phone or a re-assignment of the phone number identical to the phone number of the mobile phone whose user information was managed in the past occurs, such a transfer or re-assignment is generally notified to the customer information management apparatus first. The customer information management apparatus preferably immediately notify information on the transfer of the mobile phone or the re-assignment of the phone number to the detection section.

According to this configuration, the user ID is automatically changed with the occurrence of the transfer of the mobile phone or re-assignment of the phone number, and therefore as long as the information provider uses the changed user ID for identification of users, there will be no inconvenience that personal information associated with the old user ID would be referenced.

Furthermore, another aspect of the present invention is a gateway system interposed between a cellular phone network and the Internet, including a detection section that interprets information notified from a customer information management apparatus that manages customer information and detects the occurrence of a transfer of a mobile phone whose user information including a phone number and user ID is managed in the above described gateway system or a re-assignment of a phone number identical to a phone number of a mobile phone whose user information was managed in the past in the above described gateway system, a user ID creation section that creates a new user ID for a new user who has received the above described transfer or the above described re-assignment when the above described detection section detects the above described transfer or re-assignment, a management section that associates the new user ID for the above described new user created by the above described user ID creation section with the phone number of the mobile phone transferred to the new user or the above described reassigned phone number and manages the phone number and new user ID as user information of the new user and a conversion section that converts, when the mobile phone whose user information is registered in the above described management section accesses the server on the above described network, the phone number of the mobile phone to the above described user ID according to the above described user information of the mobile phone registered in the above described management section.

According to this configuration, the user ID is automatically changed in synchronization with the notification of the transfer of the mobile phone or the re-assignment of the phone number which is notified from the customer information management apparatus which manages customer information, and therefore as long as the gateway system uses the changed user ID for identification of users, there will be no inconvenience that personal information associated with the old user ID would be referenced.

Furthermore, the conversion section is preferably constructed of a plurality of service components and each of the above described service components preferably caches and uses the above described user information acquired from the plurality of dispersed second management sections.

In this case, each service component caches the user information incorporated from the above described second management section, while when the transfer of the above described mobile phone or the re-assignment of the phone number occurs, the user information cached so far is deleted after the replicas of the above described user information are reflected in each of the above described second management sections.

Furthermore, the management section registers the number of times the user ID is changed in the user information for each phone number and each of the above described service components notifies an error to the mobile phone when the number of times the user ID is changed in the cached user information does not match the number of times the user ID is changed stored in the above described management section.

### BRIEF DESCRIPTION OF THE DRAWINGS

The various features of novelty which characterize the invention are pointed out with particularity in the claims attached to and forming a part of this specification. For a better understanding of the invention, its operating advantages, and specific objects attained by its use, reference should be had to the accompanying drawing and descriptive matter in which there is illustrated and described a preferred embodiment of the invention.

FIG. 1 is a network configuration diagram according to an embodiment of the present invention;

FIG. 2 is a functional block diagram of the service providing server shown in FIG. 1;

FIG. 3 is a conceptual diagram of a user ID change according to the above embodiment;

FIG. 4 is a sequence diagram of the user ID change according to the above embodiment;

FIG. 5 illustrates a counter management scheme according to the above embodiment;

FIG. 6 shows a specific example of symbols to be assigned to AB codes in counter management;

FIG. 7 shows specific examples of counter values which can be output in counter management;

FIG. 8 shows user ID reflection timing according to the above embodiment; and

FIG. 9 shows a comparative example of user ID reflection timing.

### DESCRIPTION OF THE PREFERRED EMBODIMENTS

Hereinafter, an embodiment of the present invention will be explained in detail with reference to the attachment drawings.

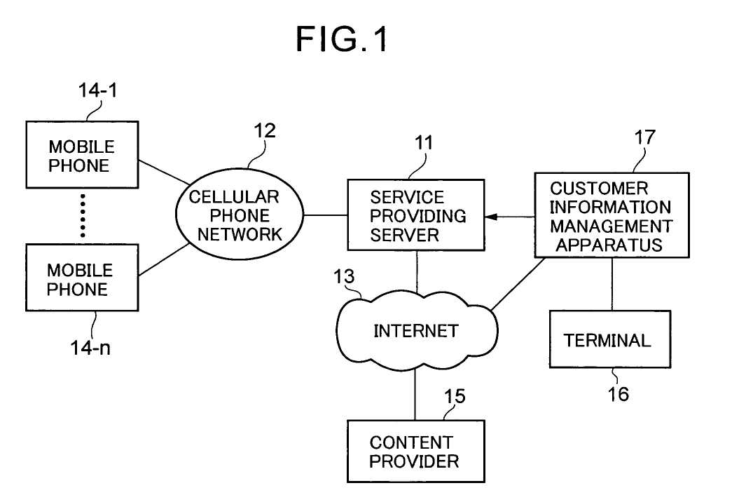

FIG. 1 is an overall configuration diagram of a network to which a user information management system according to this embodiment is applied. A service providing server 11 constitutes a user information management system. The service providing server 11 is interposed between a cellular phone network 12 and the Internet 13 and is provided with a function as a server that provides various services such as an Internet connection service to access an content provider 15 and an e-mail transmission/reception service and a function as a gateway system that performs mutual conversion of a protocol or the like.

Mobile phones 14-1 to 14-n are cellular phone terminals that have unique phone numbers given from a contracted carrier. The mobile phones 14-1 to 14-n are constructed so as to be connected to the service providing server 11 via the cellular phone network 12 and be able to access the content provider 15 via the Internet 13 there from. The content provider 15 uses user IDs created based on the phone numbers to identify users.

Information on the name change which is a change of the owner (contractor) who owns a mobile phone 14-1 to 14-n and a change of contract contents or the like is input from a reception terminal 16 and is registered in a customer information management apparatus 17 installed in the center system. For example, suppose the reception terminal 16 is a terminal operated by an operator who receives an application for cancellation, new contract, change of contents of the contract or the like from a user. Information on the contracting user is registered in a database provided for the customer information management apparatus 17. For example, the phone number of the mobile phone, name of the contractor, user ID, contract contents of an Internet connection contract, contract contents of a channel contract and account information are registered therein. The customer information management apparatus 17 transmits orders such as a registration order, deletion order to the service providing server 11 at the occurrence of new registration, contract cancellation or a change of the contract contents. Furthermore, the customer information management apparatus 17 puts together transfers or re-assigns for one day into erasure requesting mail and transmits it to the content provider 15 through the Internet 13 or a dedicated line.

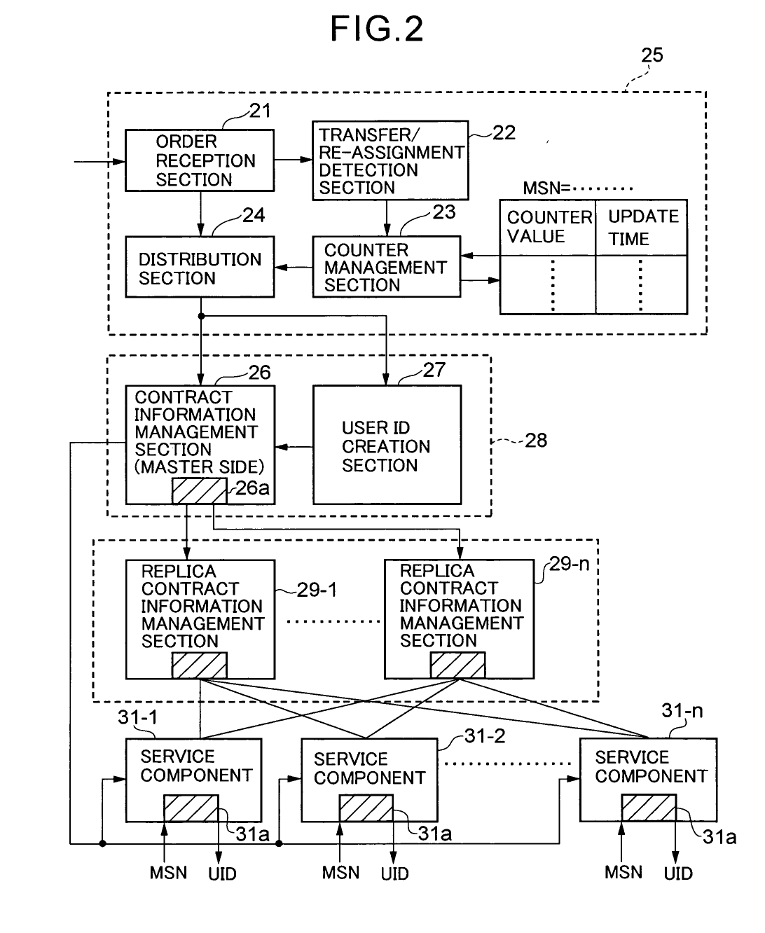

FIG. 2 is a partial functional block diagram of the service providing server 11 and is a functional block diagram of sections related to the function of managing user IDs. An order reception section 21 is a section that receives a registration order, deletion order or other orders transmitted from the customer information management apparatus 17. The transfer/re-assignment detection section 22 detects a transfer (change of name) of the mobile phone or a re-assignment (reuse of the same number) of the phone number used in the past from the orders received by the order reception section 21. A counter management section 23 counts the number of times a phone number is changed which corresponds to the number of times the user ID corresponding to one phone number is changed and outputs a count value indicating the changed phone number. More specifically, the counter management section 23 changes a phone number according to a rule which will be described later and expresses a count value. In this embodiment, the counter management section 23 manages 256 counts per phone number and stores count values and the year, month, hour, minute and second of a counter change. A distribution section 24 is a section that distributes a received order to various components making up the system and distributes a count value in real time when detecting a transfer or re-assignment. These functional blocks 21 to 24 constitute an order reception/distribution block 25.

A contract information management section 26 is a section that manages necessary user information when the service providing server 11 provides a contract service such as an Internet connection service. Examples of the user information may include the phone number of the mobile phone under the name of the contractor, name of the contractor, user ID, contract contents of the Internet connection contract, contract contents of the channel contract and number of times the user ID is changed under the same phone number, but the user information is not limited to these items. The above described user information is stored in a user information memory 26a of the contract information management section 26. The user information stored in the user information memory 26a is updated based on notification from the distribution section 24. A user ID creation section 27 is a section that creates a new user ID from the phone number (counter value) based on the phone number (counter value) changed by the counter management section 23. It creates a new user ID upon receiving notification of the changed phone number (counter value) from the distribution section 24. These functional blocks 26 and 27 constitute a contract information management block 28.

This embodiment creates replicas of the user information stored in the user information memory 26a of the contract information management section 26 and arranges the replicas in a plurality of replica contractor information management sections 29-1 to 29-n. When there is a change in the user information stored in the contract information management section 26 which becomes the master side, the changed information is reflected in the replica contractor information management sections 29-1 to 29-n which become the replica side. By arranging the user information in the plurality of replica contractor information management sections 29-1 to 29-n in this way, it is possible for a plurality of service components, which will be described later, to reference the plurality of replica contractor information management sections 29-1 to 29-n and thereby distribute the load.

Service components 31-1 to 1-31-n convert a phone number to a user ID with reference to the user information of any one of the replica contractor information management sections 29-1 to 29-n. That is, when receiving an order for access to the content provider 15 from the mobile phones 14-1 to 14-n, they provide a service of acquiring the user ID of the user from the phone number of the mobile phone. Instead of always referencing the replica contractor information management sections 29-1 to 29-n, the service components 31-1 to 31-n are configured so as to develop the user information in a cache memory 31a and to be able to acquire the user ID from the cache memory 31a without referencing the replica contractor information management sections 29-1 to 29-n.

Next, the operation of this embodiment configured as shown above will be explained.

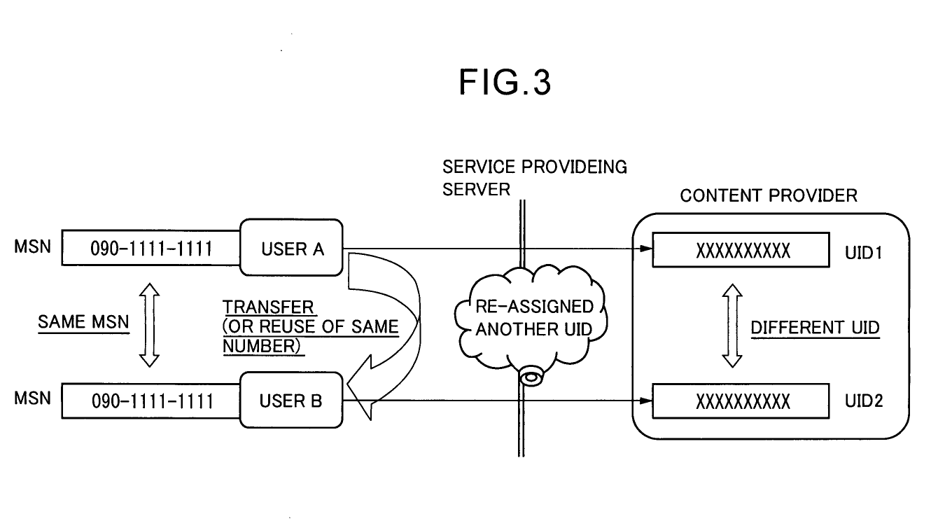

FIG. 3 is a conceptual diagram of a change of the user ID at the time of a transfer or when the same number is reused. At first, a user A is the contractor of the mobile phone which is assigned a phone number (MSN)=090-1111-1111 and the contractor of the mobile phone is changed to a user B later. The phone number (MSN) is not changed even after the contractor is changed to the user B. On the other hand, when the mobile phone accesses the content provider 15, a different user ID=UID2 is assigned from the service providing server 11 to the phone number (MSN) at the time of a transfer (name change) so that the user B can immediately receive a service from the service providing server 11. The user B can access the content provider 15 using the user ID=UID2 which is different from the one used by the user A and assigned from the service providing server 11 on the same day the procedure for the change of the name is completed.

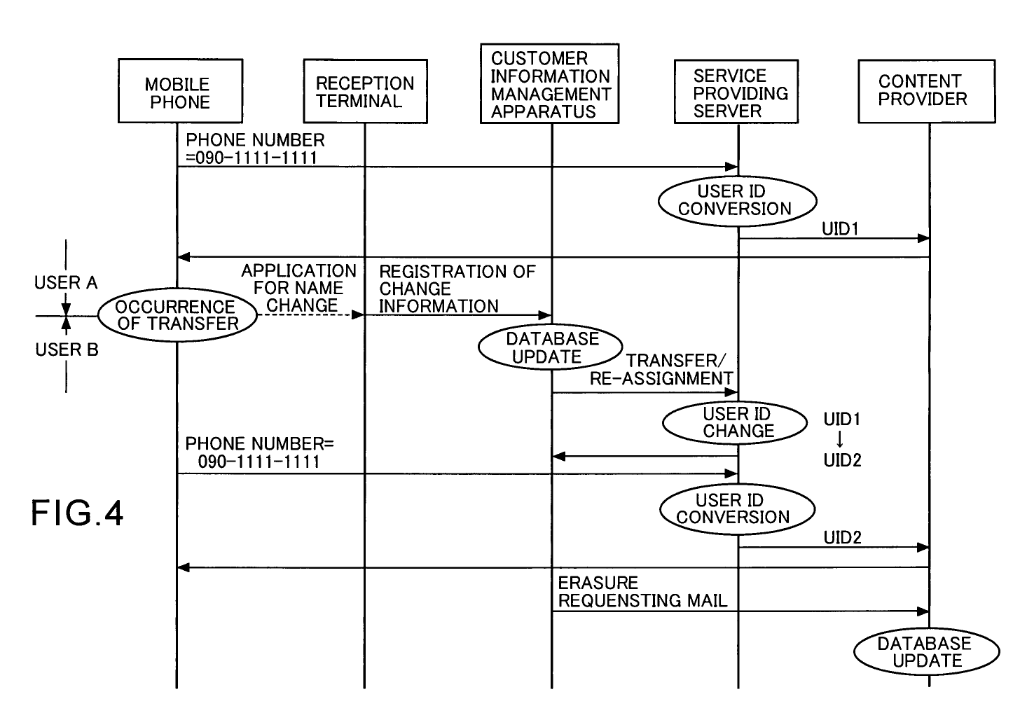

FIG. 4 is a sequence diagram showing timing of changing the user ID in the case of a transfer or reuse of the same number (re-assignment). When the user A accesses the service providing server 11 using the previously contracted mobile phone, the service providing server 11 converts the phone number of the mobile phone=090-1111-1111 to the user ID=UID1 of the user A. Then, the service providing server 11 accesses the content provider 15 specified by the user A using the user ID=UID1. The content provider 15 identifies the user using the user ID=UID1 and downloads requested contents to the mobile phone.

Here, the operation when the mobile phone is transferred from the user A to the user B will be explained. The user A or B applies for a change of the name at an information office. In response to the name change application, a procedure for changing the contractor of the mobile phone from the user A to the user B is executed and the name change information input from the reception terminal 16 is transmitted to the customer information management apparatus 17. At this time, if the contract contents are also changed together, the changed contract contents are notified, too.

The customer information management apparatus 17 deletes the user information of the user A registered for the phone number of the mobile phone=090-1111-1111, proceeds with cancellation and registers the user information on the user B. For example, when the contractor name is changed, it creates a new record and writes contract contents under the name of a new contractor. Furthermore, when the contractor name is not changed but the contract contents of the Internet connection service, the contract contents of the channel contract or the like are changed, it does not add any record and reflects the changed contract contents in the identical record.

In the case of a new contract, the reception terminal 16 accesses a phone number assignment system (not shown) and receives a assigned phone number. At this time, a phone number used in the past yet not currently in use may be assigned (reuse of the same number). The re-assigned phone number, the personal information of the contractor B and contract contents are transmitted from the reception terminal 16 to the customer information management apparatus 17 as the change information and the user information associated with the phone number is registered in a new record added to the database.

When a transfer (change of name) or re-assignment of the phone number takes place in this way, the customer information management apparatus 17 updates the database which manages user information based on the change information.

When a change occurs in the user information registered in the database, the customer information management apparatus 17 notifies the change information to the service providing server 11 in real time in the form such as a deletion order or registration order to reflect the changed user information.

In the service providing server 11, the transfer/re-assignment detection section 22 detects a notification which requires a change of the user ID from among various orders sent from the customer information management apparatus 17. More specifically, a case where a change of name or reuse of the same number is notified corresponds to a notification which requires a change of the user ID, while a case where both the contractor and the channel contract are unchanged but cancellation of an Internet connection service is notified corresponds to a notification which does not require any change of the user ID.

When the transfer/re-assignment detection section 22 detects a notification requiring a change of the user ID, the counter management section 23 counts the number of times the phone number in question is reused and outputs the count value. According to this embodiment, an identical phone number can be reused 256 times and 256 different count values are output. The user ID creation section 27 creates user IDs using the count values and can generate 256 different user IDs according to the count values for an identical phone number.

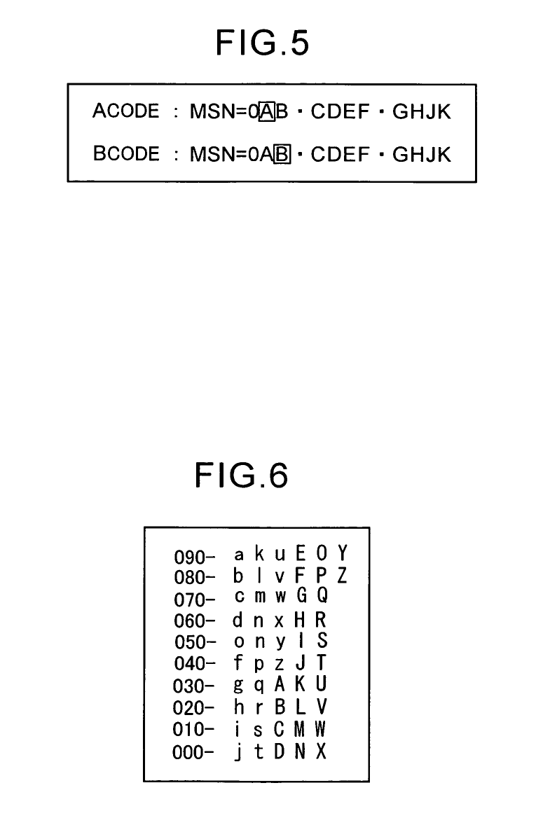

Here, a counter management scheme at the counter management section 23 will be explained. The counter management section 23 changes a phone number based on the number of times of reuse. As shown in FIG. 5, when a phone number (MSN)=OAB-CDEF-GHJK is assumed, it manages 256 counts using code A and code B of the phone number. Every time a notification requiring a change of the user ID is detected, it increments the count of code B or code A by 1. When it counts up Code B in order of a to z, A to Z and it counts up to Z with Code B, it then counts up Code A in order of a to z, A to Z.

It is desirable not to use any numbers for both Code A and Code B to avoid overlapping in a future extension of phone numbers. Furthermore, when all of a to z and A to Z are used for 090- or 080- as Code A, there will be no space for a future extension, and therefore “a, k, u, E, O, Y” are used for 090- and “b, l, v, F, P, Z” are used for 080-. For other alphanumeric, the characters shown in FIG. 6 are used.

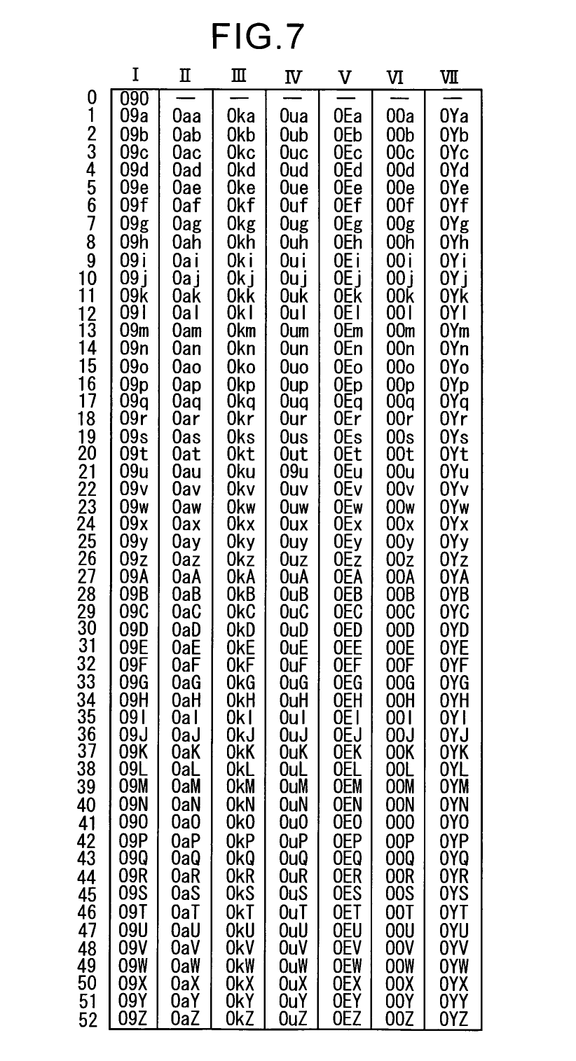

FIG. 7 shows a list of count values obtained by counting up Code A and Code B based on the above described rule when the initial 3 digits of the phone number are 090-. As shown in the same figure, in the case of 090-, 256 different numbers of I 0, I 1, . . . , I 52, II 1, . . . , V 47 can be used and the number returns to I 0 at V 47. That is, it is possible to output a count value which changes in 256 ways starting from the phone number in question by changing code A and code B with respect to phone number (MSN)=OAB-CDEF-GHJK according to the above described rule.

The above described count value is given to the user ID creation section 27. The user ID creation section 27 converts the count value given from the counter management section 23 to a user ID based on a predetermined function. Since 256 different count values can be generated per phone number, 256 different user IDs per phone number can also be generated in response thereto. In this way, this embodiment creates a plurality of user IDs by changing a phone number (OAB) based on the number of times of reuse.

The user ID created by the user ID creation section 27 is stored in the user information memory 26a of the contract information management section (master side) 26. As a result, the contractor of the mobile phone is changed from the user A to the user B, and therefore another user ID is given as the user ID, and reflected in the user information in the user information memory 26a.

When a change occurs in the user information in the user information memory 26a, the contract information management section (master side) 26 notifies the changed user information (all or only the changed part) to the replica contract information management sections 29-1 to 29-n and reflects the change contents.

Here, the timing at which the contract information management section 26 which constitutes the contract information management block 28 notifies the changed user information to the replica contract information management sections 29-1 to 29-n and reflects the changed user information will be explained.

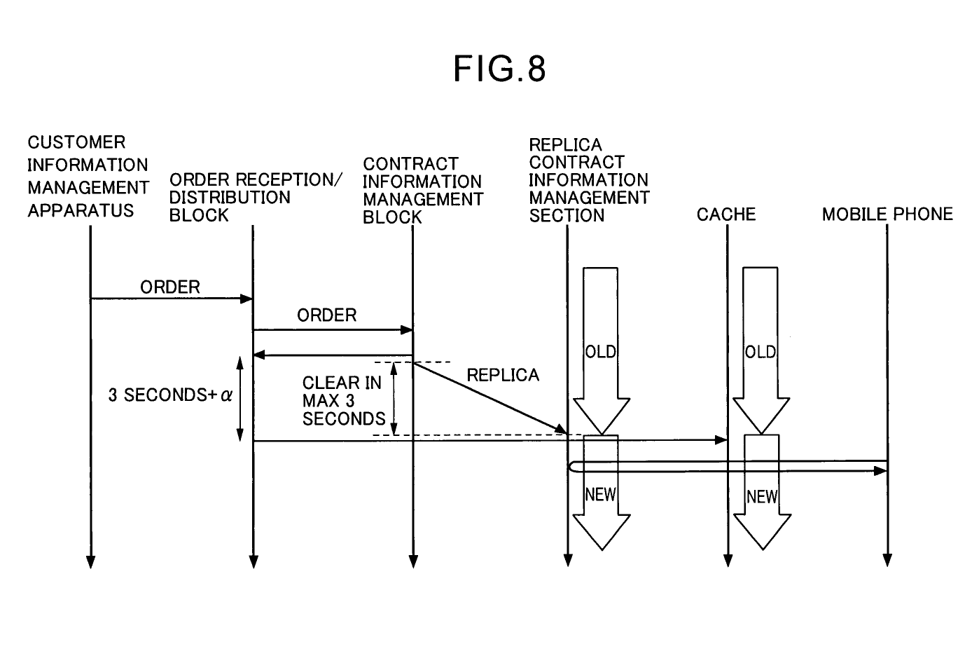

As shown in FIG. 8, an order which the service providing server 11 has received from the customer information management apparatus 17 includes a notification (transfer/re-assignment) requiring a change of the user ID, a counter value counted up based on the number of times of usage as well as the order is given to the contract information management block 28 from the order reception/distribution block 25 and another user ID is generated at the contract information management block 28 based on the count value. The user ID generated in this way is notified to each replica contract information management section 29-1 to 29-n in approximately 3 seconds and reflected therein.

The order reception/distribution block 25 clears the old user ID cached in the service components 31-1 to 31-n when 3 seconds+α passes after a count value together with the order is notified to the contract information management block 28. That is, the old user ID of the service components 31-1 to 31-n is cleared after a lapse of time in which the new user ID is reflected in the replica contract information management sections 29-1 to 29-n.

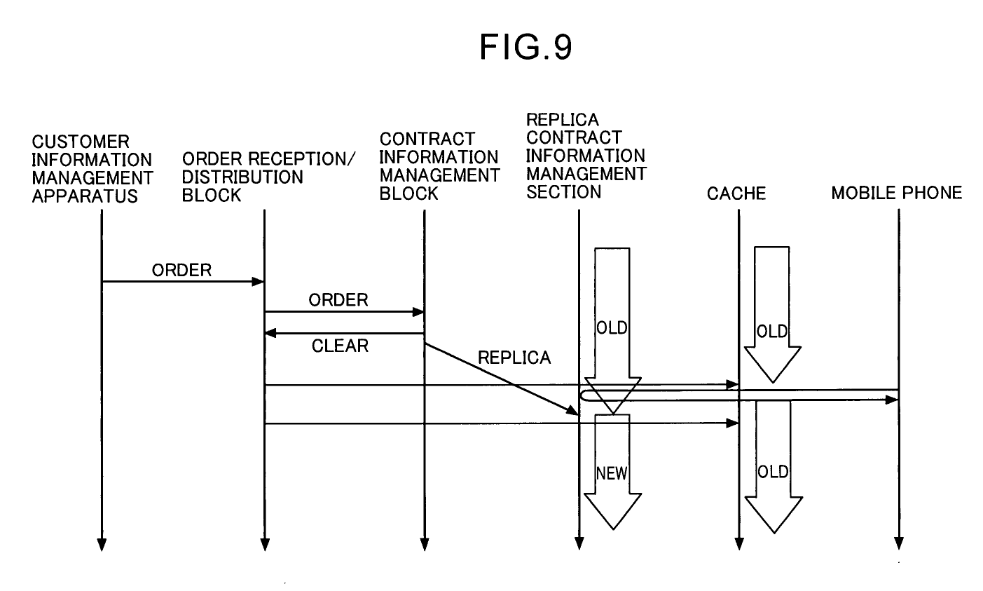

FIG. 9 illustrates a problem when clearing the old user ID of the service components 31-1 to 31-n before the time in which the new user ID is reflected in the replica contract information management sections 29-1 to 29-n passes. As shown in the same figure, if the cache is cleared before the new user ID is reflected in the replica contract information management sections 29-1 to 29-n, the user information of the old user is cached when there is access from the mobile phone.

In this way, as shown in FIG. 8, it is possible to prevent the problem that the user information of the old user is cached and mistakenly displayed by clearing the cache after securing the time in which the new user ID is reflected in the replica contract information management sections 29-1 to 29-n.

In this embodiment, the service components 31-1 to 31-n are configured so as to compare the number of times the user ID is changed stored in the contract information management block 28 with the number of times the cached user ID is changed and carry out error handling if they are different. For example, a screen such as “now, in the process of registration” is returned to the mobile phone. In this way, it is possible to prevent the user information of the old user from being displayed even if there is access by the mobile phone in a waiting period until the new user ID is reflected in the replica contract information management sections 29-1 to 29-n.

As shown in FIG. 4, the user B sends a request for access to the customer information management apparatus 17 from the mobile phone to the service providing server 11 after the procedure for a change of the name to the user B is completed and before the erasure requesting mail is transmitted from the customer information management apparatus 17 to the content provider 15. In this case, in the service providing server 11, for example, the service component 31-1 acquires a user ID with reference to the cache 31a or the user information in the replica contract information management sections 29-1 to 29-n. As described above, at this time, the new user ID=UID2 for the user B is already reflected in the user information in the replica contract information management sections 29-1 to 29-n and the old user information in the cache 31a is cleared. Therefore, the service component 31-1 can acquire the new user ID=UID2 created for the user B as the user ID from the replica contract information management sections 29-1 to 29-n and stores it in the cache 31a. The service component 31-1 then accesses the content provider 15 using the acquired user ID=UID2 and receives the contents.

The customer information management apparatus 17 creates erasure requesting mail which puts together the cancellation information of the user whose contract has been canceled within a predetermined period of time (e.g., 1 day) and transmits it to the content provider 15. The content provider 15 which has received the erasure requesting mail deletes the personal information (including the user ID) of the user in question from the database.

The customer information management apparatus 17 or service providing server 11 notifies the user information including the user ID of the new contractor to the content provider 15 after registration in the own database. In this embodiment, when the service providing server 11 accesses the content provider 15 for the first time after the change of the name, it notifies the user ID and predetermined user information.

In this way, according to this embodiment, the service providing server 11 detects a notification requiring a change of the user ID such as a transfer or re-assignment and executes processing of the change from the user ID of the old user A to the user ID of the new user B in real time, and it is thereby possible to use various services according to the contract contents immediately after the contract is completed and prevent the inconvenience that the personal information of the user who transferred the ownership or the user before the re-assignment may be mistakenly displayed even if there is access before the database in the content provider 15 is updated.

What is claimed is:

1. A system which manages phone numbers uniquely assigned to individual mobile phones for communication on a cellular phone network in correspondence with user IDs uniquely assigned to the respective users of the mobile phones to identify the users by a server on a network other than said cellular phone network, comprising:
a detection section that detects the occurrence of a transfer of a mobile phone whose user information including a phone number and user ID is managed in said system or a re-assignment of a phone number identical to a phone number of a mobile phone whose user information was managed in the past in said system;
a user ID creation section that creates a new user ID for a new user to whom said mobile phone has been transferred or the same phone number has been re-assigned when said detection section detects said transfer or said re-assignment; and
a management section that associates the new user ID for said new user created by said user ID creation section with the phone number of the mobile phone transferred to said new user or said re-assigned phone number and manages said phone number and new user ID as user information of said new user.

2. The system according to claim 1, further comprising a counter section that counts up a predetermined digit of a phone number as a start position according to codes other than numerical values every time said detection section detects a transfer or re-assignment,
wherein said user ID creation section converts the count value output by said counter section to a user ID.

3. The system according to claim 1, wherein said management section comprises a first management section that stores master information of said user information and a plurality of second management sections that store replicas of said master information and said plurality of second management sections can reference the replicas of said master information in parallel.

4. A gateway system interposed between a cellular phone network and the Internet, comprising:
a detection section that interprets information notified from a customer information management apparatus that manages customer information and detects the occurrence of a transfer of a mobile phone whose user information including a phone number and user ID is managed in said gateway system or a re-assignment of a phone number identical to a phone number of a mobile phone whose user information was managed in the past in said gateway system;
a user ID creation section that creates a new user ID for a new user to whom said mobile phone has been transferred or the same phone number has been re-assigned when said detection section detects said transfer or said re-assignment;
a management section that associates the new user ID for said new user created by said user ID creation section with the phone number of the mobile phone transferred to said new user or said re-assigned phone number and manages said phone number and new user ID as user information of said new user; and
a conversion section that converts, when the mobile phone whose user information is registered in said management section accesses the server on said network, the phone number of said mobile phone to said user ID according to said user information of said mobile phone registered in said management section.

5. The gateway system according to claim 4, wherein said management section comprises a first management section that manages master information of said user information and a plurality of second management sections that store replicas of the user information replicated from said master information, and
said conversion section acquires said user information from any one of said plurality of second management sections.

6. The gateway system according to claim 5, wherein said conversion section is constructed of a plurality of service components and each of said service components caches and uses said user information acquired from said plurality of second management sections.

7. The gateway system according to claim 6, wherein each of said service components caches the user information incorporated from said second management section, while when a transfer of said mobile phone or re-assignment of the phone number occurs, the user information cached so far is deleted after the replicas of said user information are reflected in each of said second management sections.

8. The gateway system according to claim 7, wherein said management section registers the number of times the user ID is changed in the user information for each phone number and each of said service components notifies an error to the mobile phone when the number of times the user ID is changed in the cached user information does not match the number of times the user ID is changed stored in said management section.

9. A method of managing phone numbers of mobile phones and user IDs to identify users of the mobile phones in a gateway system interposed between a cellular phone network and the Internet, comprising:
interpreting information notified from a customer information management apparatus that manages customer information and detecting the occurrence of a transfer of a mobile phone whose user information including a phone number and user ID is managed in said gateway system or re-assignment of a phone number identical to a phone number of a mobile phone whose user information was managed in the past by said gateway system;
creating a new user ID for a new user to whom said mobile phone has been transferred or the same phone number has been re-assigned when said transfer or said re-assignment is detected;
associating a new user ID for said new user created with the phone number of the mobile phone transferred to said new user or said re-assigned phone number and managing said phone number and new user ID as the user information of said new user; and
converting, when said mobile phone accesses a server on said Internet, the phone number of said mobile phone to said user ID according to said user information of said mobile phone.
